(19) United States
(12) Patent Application Publication
(10) Pub. No.: US 2025/0366589 A1
(43) Pub. Date: Dec. 4, 2025

(54) RAZOR CARTRIDGE PROTECTIVE CASE

(71) Applicant: DORCO CO., LTD., Yongin-si (KR)

(72) Inventors: Young jin LEE, Seoul (KR); Jong Jin JEONG, Seoul (KR)

(21) Appl. No.: 19/300,198

(22) Filed: Aug. 14, 2025

Related U.S. Application Data
(63) Continuation of application No. PCT/KR2024/002084, filed on Feb. 14, 2024.

(30) Foreign Application Priority Data
Feb. 14, 2023 (KR) 10-2023-0019491

(51) Int. Cl. A45D 27/22

(52) U.S. Cl. CPC A45D 27/225

(57) ABSTRACT

Proposed is at least one razor cartridge protective case each including a receiving space configured to receive at least a portion of a razor cartridge extending in a longitudinal direction. Each cartridge protective case may include a front wall disposed at a front of the receiving space. Each case may also include a rear wall disposed at a rear of the receiving space and configured to be opposed to the front wall in a lateral direction. One of the front wall and the rear wall may include one or more first coupling portions. The other one of the front wall and the rear wall may include one or more second coupling portions. The first coupling portion may be detachably coupled to the second coupling portion of an another razor cartridge protective case along a height direction.

### CROSS-REFERENCE TO RELATED APPLICATIONS

This is a continuation application of International Patent Application No. PCT/KR2024/002084 filed on Feb. 14, 2024, which claims priority to Korean Patent Application Number 10-2023-0019491, filed Feb. 14, 2023, the disclosure of each of which is incorporated by reference herein in its entirety.

### BACKGROUND

### Technical Field

The present disclosure in at least one embodiment relates to a razor cartridge protective case.

### Description of Related Technology

Typically, a razor cartridge is sold coupled to a cartridge receptacle. For example, cartridges are sold by the piece as coupled to a protective case in the form of a cover, or a plurality of cartridges are sold coupled to a dispenser in the form of a case. Being traded as coupled to a protective case or dispenser, the razor cartridges can be transported or sold unharmed from impact while saving the user when opening the packaging from being cut by the razor blades.

### SUMMARY

One aspect is a razor cartridge protective case that can reduce the overall manufacturing cost of a razor product while minimizing the amount of plastic material used.

Another aspect is at least one razor cartridge protective cases each comprising a receiving space configured to receive at least a portion of a razor cartridge extending in a longitudinal direction, the at least one razor cartridge protective cases each further comprising: a first side wall disposed on one side of the receiving space; and a second side wall disposed on the other side of the receiving space and configured to be opposed to the first side wall in the longitudinal direction, wherein any one of the first side wall and the second side wall comprises one or more third coupling portions, wherein the other one of the first side wall and the second side wall comprises one or more fourth coupling portions, and wherein the third coupling portion is configured to be detachably coupled to the fourth coupling portion of an another razor cartridge protective case.

According to at least one embodiment of the present disclosure, the razor cartridge protective cases are capable of being interconnected as they are individually coupled with the cartridges, resulting in reduced overall manufacturing cost of the razor products and the minimized amount of plastic material used.

### BRIEF DESCRIPTION OF THE DRAWINGS

FIG. 1 is a top and partially enlarged view of a razor cartridge protective case according to at least one embodiment of the present disclosure.

FIGS. 2A and 2B are front and rear exploded perspective views of a razor cartridge protective case and razor cartridge in a detached state, according to at least one embodiment of the present disclosure.

FIGS. 3A and 3B are top and cross-sectional views depicting an example of two razor cartridge protective cases coupled in a lateral direction, according to at least one embodiment of the present disclosure.

FIG. 4 is a sectional view from the side of the razor cartridge protective case of FIGS. 2A and 2B with the razor cartridge seated and cut in the direction A-A′.

FIG. 5 is a bottom perspective view of a razor cartridge protective case according to at least one embodiment of the present disclosure.

FIG. 6 is an illustration of four razor cartridge protective cases according to at least one embodiment of the present disclosure coupled together in the lateral and height directions.

FIGS. 7A and 7B are top and longitudinal sectional views illustrating an example of two razor cartridge protective cases coupled in a longitudinal direction or in tandem according to at least one embodiment of the present disclosure.

FIG. 8 is a diagram illustrating three razor cartridge protective cases coupled in a longitudinal direction and a lateral direction, according to at least one embodiment of the present disclosure.

FIG. 9 is a diagram illustrating eight razor cartridge protective cases coupled in the lateral direction, the longitudinal direction, and a height direction, according to at least one embodiment of the present disclosure.

FIG. 10 is an exploded view of a razor cartridge protective case and razor cartridge in a detached state, according to another embodiment of the present disclosure.

FIG. 11 is a sectional view from the side of the razor cartridge protective case of FIG. 10 with the razor cartridge seated and cut in the direction D-D′.

### DETAILED DESCRIPTION

Generally, razor cartridge protection mechanism only provides either the protective case or the dispenser, not the benefit of the two. Further, manufacturing the protective case and the dispenser separately has failed to counter the increased manufacturing costs.

On the other hand, as the seriousness of environmental destruction has recently emerged, every country and various international organizations are establishing measures related to environmental regulations. For example, countermeasures such as banning the use of disposable plastics or reducing the amount of plastics used are being established.

Both the protective case and the dispenser are generally made of plastic, so the overall amount of plastic material is increased if the protective case and the dispenser are manufactured separately.

Therefore, to reduce the manufacturing cost of razor products while complying with various environmental regulations toward eco-friendliness and measures that have recently emerged, it is critical to improve productivity and minimize the use of plastic materials in products that accommodate razor cartridges.

Hereinafter, some embodiments of the present disclosure will be described in detail with reference to the accompanying drawings. In the following description, like reference numerals preferably designate like elements, although the elements are shown in different drawings. Further, for the purpose of clarity and for brevity, the following description of some embodiments will omit a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, to not exclude thereof unless specifically stated to the contrary.

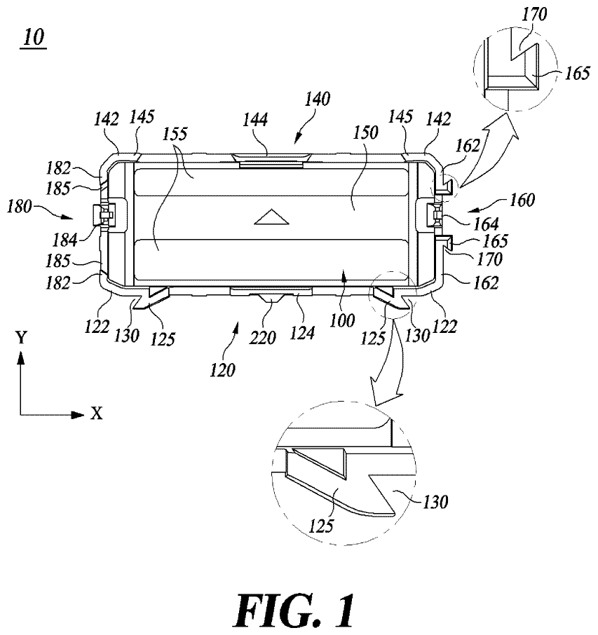

FIG. 1 is a top and partially enlarged view of a razor cartridge protective case 10 according to at least one embodiment of the present disclosure.

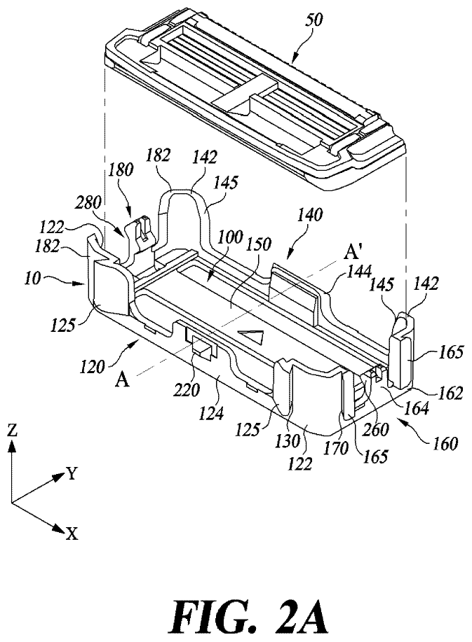

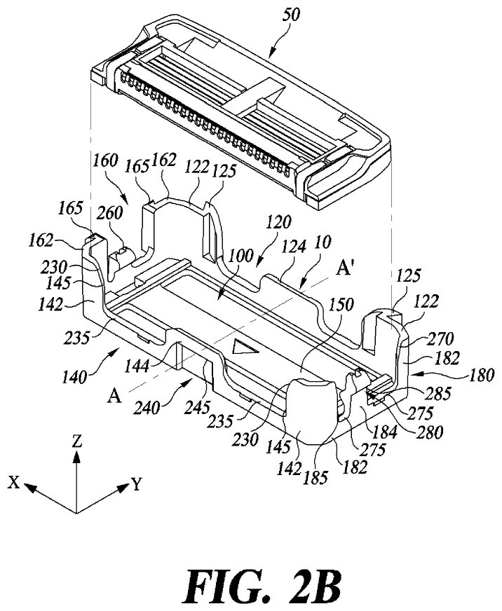

FIGS. 2A and 2B are front and rear exploded perspective views of the razor cartridge protective case 10 and a razor cartridge 50 in a detached state, according to at least one embodiment of the present disclosure. Specifically, FIG. 2A is a front perspective view and FIG. 2B is a rear perspective view.

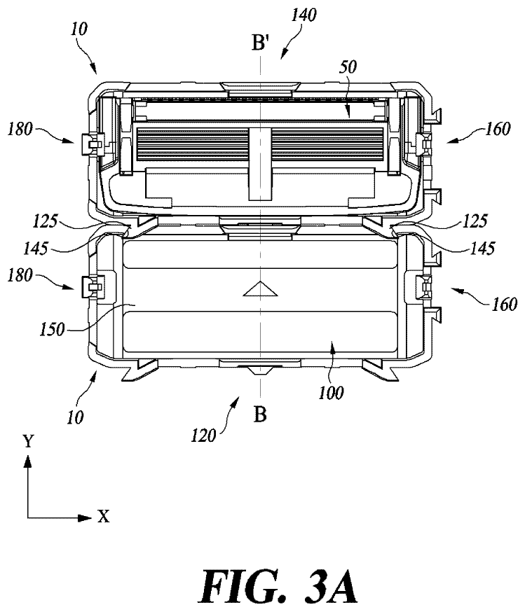

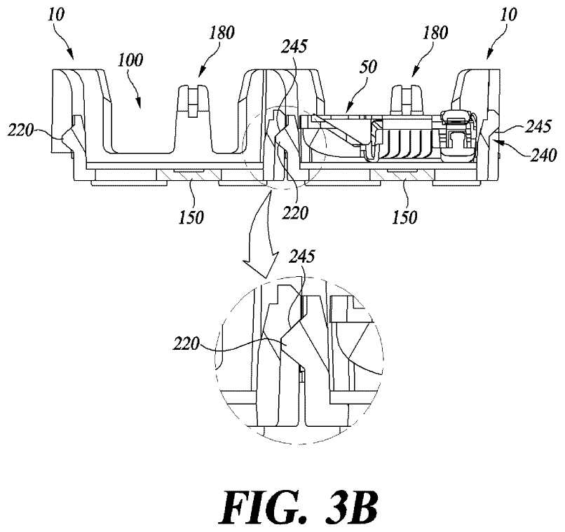

FIGS. 3A and 3B are top and cross-sectional views depicting an example of two razor cartridge protective cases 10 coupled in a lateral direction, according to at least one embodiment of the present disclosure. Specifically, FIG. 3A is a top view, and FIG. 3B is a cross-sectional view from the side after cutting the two razor cartridge protective cases 10 of FIG. 3A in the direction B-B′.

Referring to FIGS. 1, 2A, and 2B, the razor cartridge protective case 10 according to at least one embodiment of the present disclosure includes all or part of a receiving space 100, a front wall 120, a rear wall 140, a first side wall 160 and a second side wall 180, and a base 150.

The receiving space 100 is a space formed in the center of the razor cartridge protective case 10, which is configured to receive at least a portion of the razor cartridge 50 extending in a longitudinal direction. Here, the longitudinal direction may mean a direction parallel to the X-axis, for example with reference to FIG. 1.

The razor cartridge 50 received in the receiving space 100 may remain therein unless a predetermined external force is applied or a user performs any other manipulation.

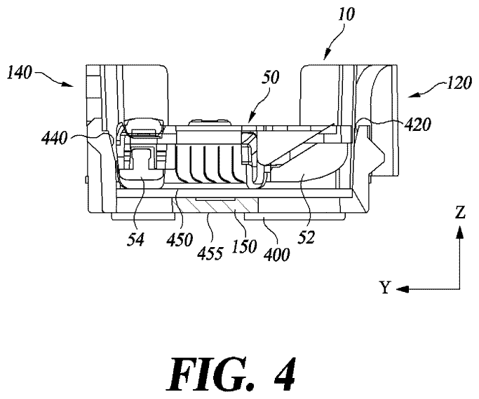

The front wall 120 is disposed at the front of the receiving space 100, and the rear wall 140 is disposed at the rear of the receiving space 100. The front and rear of the receiving space 100 refer to directions adjacent to a guard (52 in FIG. 4) and a cap (56 in FIG. 4) of the razor cartridge 50, respectively, when the razor cartridge 50 is coupled to the razor cartridge protective case 10.

The front wall 120 and the rear wall 140 may be configured to oppose in the lateral direction perpendicular to the longitudinal direction. Here, the lateral direction may mean, for example, a direction parallel to the y-axis with reference to FIG. 1.

The first side wall 160 is disposed on one longitudinal side of the receiving space 100, and the second side wall 180 is disposed on the other longitudinal side of the receiving space 100. Thus, the first side wall 160 and the second side wall 180 may be configured to oppose each other in the longitudinal direction, and the first side wall 160 and the second side wall 180 may be disposed on longitudinal sides of the receiving space 100 between the front wall 120 and the rear wall 140.

The first side wall 160 and the second side wall 180 may be connected to the front wall 120 and/or the rear wall 140 at corner regions of the razor cartridge protective case 10, but they may also be separate.

Further, the front wall 120, rear wall 140, first side wall 160, and second side wall 180 are preferably configured to have a height greater than the thickness of the razor cartridge 50, to secure a sufficiently large amount of the receiving space 100 for receiving the razor cartridge 50. Here, the structures formed by the front wall 120, rear wall 140, first side wall 160, and second side wall 180 are not necessarily limited to structures forming a continuous plane and may include all structures that can define at least a portion of the receiving space 100.

The base 150 may be disposed in the receiving space at its lower portion in the height direction. Here, the height direction may mean a direction perpendicular to the longitudinal and lateral directions, such as a direction parallel to the z-axis direction with reference to FIGS. 2A and 2B.

While the razor cartridge 50 is received in the receiving space 100, the base 150 may cover the razor blades of the razor cartridge 50. This may prevent the razor blades from breaking due to external forces, impacts, or the like, as well as safety concerns of users cutting themselves on the razor blades.

The following description will be made with respect to a lateral coupling between razor cartridge protective cases 10 according to at least one embodiment of the present disclosure.

One of the front wall 120 and the rear wall 140 may include at least one first coupling portion 125, and the other of the front wall 120 and the rear wall 140 may include at least one second coupling portion 145. For example, when the first coupling portion 125 is included in the front wall 120, the second coupling portion 145 may be included in the rear wall 140, and when the first coupling portion 125 is included in the rear wall 140, the second coupling portion 145 may be included in the front wall 120.

The following drawings and description of the present disclosure illustrate that the front wall 120 includes the first coupling portion 125 and the rear wall 140 includes the second coupling portion 145, but the present disclosure is not necessarily limited to this configuration. Accordingly, the description below may be equally applicable to embodiments in which the front wall 120 includes the second coupling portion 145 and the rear wall 140 includes the first coupling portion 125.

Referring to FIGS. 2A, 2B, and 3A, the first coupling portion 125 and the second coupling portion 145 may be configured to be intercoupled slidingly along the height direction. Referring to FIGS. 3A and 3B, it can be seen that the sliding coupling between the first coupling portion and the second coupling portion is completed. However, sliding coupling is only one example of a coupling method of the first coupling portion 125 and the second coupling portion 145, and the coupling method of the first coupling portion 125 and the second coupling portion 145 may include all arrangements in which they can be releasably coupled to each other.

In this manner, the razor cartridge protective case 10 according to at least one embodiment of the present disclosure can function as a protective case that protects the razor cartridge 50, while simultaneously functioning as a dispenser that accommodates multiple razor cartridges when multiples of the razor cartridge protective case 10 are coupled.

The razor cartridge protective cases 10 according to at least one embodiment of the present disclosure may be configured to allow the razor cartridge protective cases 10 to be intercoupled as many as any number of razor cartridges 50 required at the convenience of the manufacturer or user. By doing so, the razor cartridge protective case 10 can provide the double duty of a protective case and a dispenser, which has the effect of reducing the overall manufacturing cost and minimizing the amount of plastic material otherwise used for manufacturing the protective case, dispenser, and the like.

In some embodiments of the present disclosure, either of the front wall 120 and the rear wall 140 may include a pair of first coupling portions 125 spaced apart in the longitudinal direction from each other, and the other of the front wall 120 and the rear wall 140 may include a pair of second coupling portions 145 spaced apart in the longitudinal direction from each other. However, the first coupling portion 125 and the second coupling portion 145 need not necessarily be a pair, and they may each be one, three, or more.

The pair of first coupling portions 125 may protrude in a direction away from the receiving space 100. For example, each first coupling portion 125 may be configured to extend longitudinally outwardly to form a first sliding space 130. In this case, the pair of second coupling portions 145 may be configured to be slidable along the height direction within the first sliding space 130.

Referring to FIGS. 3A and 3B, by coupling the first coupling portion 125 and the second coupling portion 145 through the first sliding space 130, two razor cartridge protective cases 10 when coupled in the lateral direction may be prevented from being detached in the lateral and longitudinal directions relative to each other.

The entirety of the first coupling portion 125 may protrude in the oblique direction, although only a portion of the first coupling portion 125 may protrude in the oblique direction. For example, a pair of first coupling portions 125 may be shaped to have portions that protrude in a direction parallel to each other with the remaining portions extending in a direction away from each other.

Referring to FIG. 3A, when the pair of first coupling portions 125 and the pair of second coupling portions 145 are slidably intercoupled, at least some of the pair of first coupling portions 125 may be configured to be located within the receiving space 100.

In this way, two razor cartridge protective cases 10 that are coupled in the lateral direction or side by side can be brought closer together, which establishes a more solid coupling between the razor cartridge protective cases 10. Referring to FIGS. 2A, 2B, and 3B, either of the front wall 120 and the rear wall 140 may include a first fixing portion 220 configured to elastically couple with the other of the front wall 120 and the rear wall 140. The elastic coupling may include, but is not necessarily limited to, at least one of a hook coupling, a latch coupling, and a snap-fit coupling. Thus, the elastic coupling may include all coupling methods utilizing elastic forces in addition to the coupling methods described above.

The first fixing portion 220 may be included in a wall on which the first coupling portion 125 is formed. In this case, the first fixing portion 220 may be configured to elastically couple with a wall in which the second coupling portion 145 is formed when the first coupling portion 125 and the second coupling portion 145 are slidingly coupled.

The other of the front wall 120 and the rear wall 140 may include a first fixing step 240 that limits movement of the first fixing portion 220 in the height direction.

The first fixing step 240 may be included in the wall in which the second coupling portion 145 is formed. In this case, the first fixing step 240 may be configured to limit upward movement of the first fixing portion 220 in the height direction when the first coupling portion 125 and the second coupling portion 145 are slidingly coupled between the razor cartridge protective cases 10. However, the present disclosure is not necessarily limited to this configuration, and depending on the position of the first fixing portion 220 and the first fixing step 240 or how they are elastically coupled, the first fixing step 240 may limit downward movement of the first fixing portion 220, or may limit both upward and downward movement thereof.

The other of the front wall 120 and the rear wall 140 may include a first stop surface 235 configured to limit downward movement of the first coupling portion 125. Further, the first fixing step 240 may include a second stop surface 245 configured to limit the upward movement of the first fixing portion 220.

With the first coupling portion 125 and the second coupling portion 145 slidingly coupled, the first stop surface 235 may engage a lower portion of the first coupling portion 125, and the second stop surface 245 may engage an upper portion of the first fixing portion 220. Thereby, the first stop surface 235 and the second stop surface 245 may limit the height-direction movement of the first coupling portion 125 and the first fixing portion 220, respectively, enabling a more solid sliding coupling of the first coupling portion 125 and the second coupling portion 145.

Referring to FIGS. 1, 2A, and 2B, the front wall 120 may include a pair of longitudinal front walls 122 spaced apart from each other in the longitudinal direction and at least one central front wall 124 disposed between the pair of longitudinal front walls 122. Hollow spaces may be formed between at least one central front wall 124 and the pair of longitudinal front walls 122, which can reduce the amount of plastic utilized.

The rear wall 140 may include a pair of longitudinal rear walls 142 spaced apart from each other in the longitudinal direction and at least one central rear wall 144 disposed between the pair of longitudinal rear walls 142. Hollow spaces may be formed between at least one central rear wall 144 and the pair of longitudinal rear walls 142, which can reduce the amount of plastic utilized.

The pair of longitudinal front walls 122 is preferably formed to positionally correspond to the pair of longitudinal rear walls 142 with respect to the lateral direction, as is the case between the at least one central front wall 124 and the at least one central rear wall 144.

Any one of the pair of longitudinal front walls 122 and the pair of longitudinal rear walls 142 may include the first coupling portions 125, and the other one of the pair of longitudinal front walls 122 and the pair of longitudinal rear walls 142 may include the second coupling portions 145.

Any one of the central front wall 124 and the central rear wall 144 may include the first fixing portion 220, and the other one of the central front wall 124 and the central rear wall 144 may include the first fixing step 240.

The pair of first coupling portions 125 may be symmetrical in the longitudinal direction relative to the point where the first fixing portion 220 is formed, and the pair of second coupling portions 145 may be symmetrical in the longitudinal direction relative to the point where the first fixing step 240 is formed. This allows implementation of the razor cartridge protective case 10 having the pair of first coupling portions 125 and the pair of second coupling portions 145 that can be reliably coupled while minimizing the amount of plastic material used.

FIGS. 1 and 2A illustrate that the first fixing portion 220 is disposed in the middle between the pair of first coupling portions 125 and that the first fixing step 240 is disposed in the middle between the pair of second coupling portions 145, but the present disclosure is not limited to this configuration. For example, the first fixing portion 220 or the first fixing step 240 may be skewed to one of the pair of first coupling portions 125 or one of the pair of second coupling portions 145.

Referring to FIGS. 2A and 2B, the pair of second coupling portions 145 may each be formed with a first inclined guide surface 230 that is inclined with respect to the height direction. For example, the first inclined guide surface 230 may be formed to be inclined toward the longitudinal direction with respect to the height direction.

When a first coupling portion 125 and a second coupling portion 145 are slidingly coupled between the razor cartridge protective cases 10, the first inclined guide surface 230 may be adapted to guide the coupling direction of the first coupling portion 125. For example, when the first coupling portion 125 initiates a sliding engagement in the height direction at an upper portion of the second coupling portion 145, the first inclined guide surface 230 can facilitate alignment of the first coupling portion 125 with the second coupling portion 145.

FIG. 4 is a sectional view from the side of the razor cartridge protective case 10 of FIGS. 2A and 2B with the razor cartridge 50 seated and cut in the direction A-A′.

Referring to FIG. 4, at least one of the front wall 120 and the rear wall 140 may include a second inclined guide surface 420, 440 formed to be inclined with respect to the height direction. For example, the second inclined guide surface 420, 440 may be formed to be inclined in a direction facing the lateral direction with respect to the height direction. In this case, the second inclined guide surface 420, 440 may form an angle of 2° to 13° with the z-axis of FIG. 4, although the present disclosure is not necessarily limited to this configuration.

The second inclined guide surface 420, 440 may be configured to guide the razor cartridge 50 when received in the receiving space 100. For example, the second inclined guide surface 420, 440 may be formed to facilitate the insertion of the razor cartridge 50 from an upper portion of the receiving space 100 into a lower portion thereof.

FIG. 4 illustrates that both the front wall 120 and the rear wall 140 are formed to slope in the lateral direction relative to the height direction, with at least a portion of the front wall 120 and at least a portion of the rear wall 140 are deflected from each other in the lateral direction, but as long as they facilitate insertion of the razor cartridge 50 into the receiving space 100, the present disclosure is not necessarily limited to this configuration.

The following description relates to the coupling of the razor cartridge protective cases 10 in the height direction, according to at least one embodiment of the present disclosure.

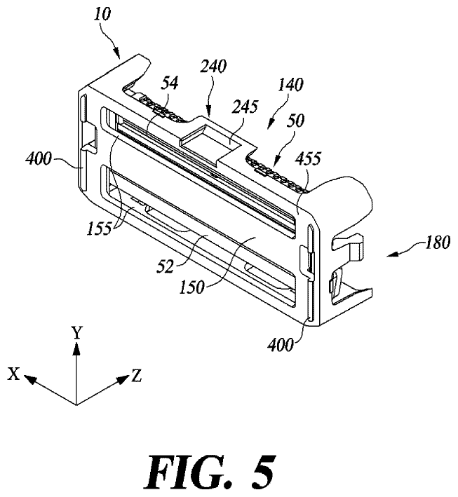

FIG. 5 is a bottom perspective view of a razor cartridge protective case 10 according to at least one embodiment of the present disclosure.

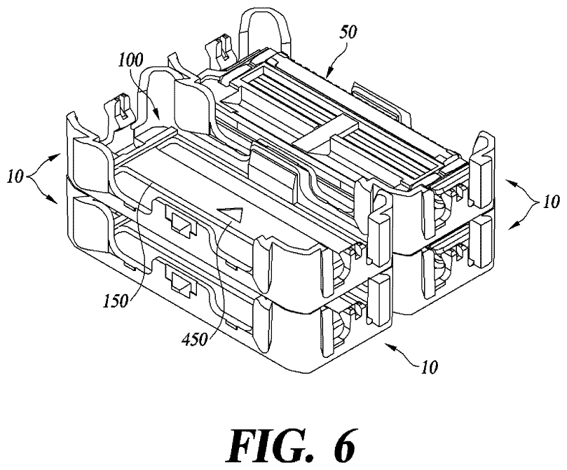

FIG. 6 is an illustration of four razor cartridge protective cases 10 according to at least one embodiment of the present disclosure coupled together in the lateral and height directions.

Referring to FIGS. 1 and 4 in conjunction with FIGS. 5 and 6, the base 150 may include a base upper surface 450 adjacent to the receiving space 100 and a base lower surface 455 opposite the base upper surface 450.

The base lower surface 455 of the subject razor cartridge protective case 10 may include an upper and lower coupling portion 400 configured to join with a upper portion of another razor cartridge protective case 10. The upper and lower coupling portion 400 may be configured to join with or held by one end of at least one of the front wall 120, the rear wall 140, the first side wall 160, and the second side wall 180 in the height direction.

A plurality of the upper and lower coupling portions 400 may protrude downwardly from the base lower surface 455 in its regions adjacent to longitudinally opposite ends of the base lower surface 455. However, the number and locations of the upper and lower coupling portions 400 are not necessarily so limited, and the upper and lower coupling portions 400 may have a recessed shape rather than a protruding shape on the base lower surface 455.

As shown in FIG. 6, the razor cartridge protective case 10 according to at least one embodiment of the present disclosure may also be configured to allow for coupling with another razor cartridge protective case 10 in the height direction by using the upper and lower coupling portion 400.

The base 150 may include at least one opening 155 that extends from the base upper surface 450 to the base lower surface 455. The at least one opening 155 may correspond to at least one of a guard 52 and a cap 54 of the razor cartridge 50. For example, a pair of openings 155 may be formed at positions corresponding to the guard 52 and the cap 54, respectively, although the present disclosure is not necessarily limited to this configuration.

Through the at least one opening 155, a lubrication member (not shown), which may be included in the cap 54, and/or a guard portion (not shown), which may be included in the guard 52, may communicate with the exterior of the receiving space 100 and remain dry.

The following description relates to the longitudinal coupling of the razor cartridge protective cases 10 according to at least one embodiment of the present disclosure.

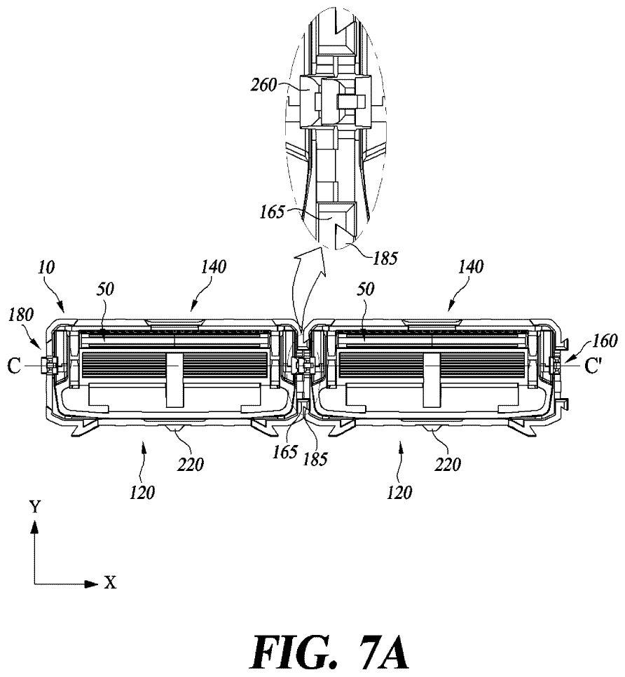

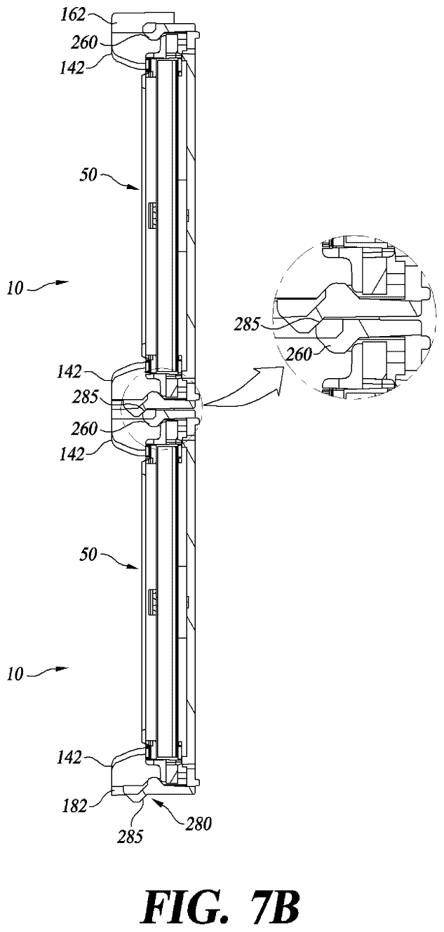

FIGS. 7A and 7B are top and longitudinal sectional views illustrating an example of two razor cartridge protective cases coupled in the longitudinal direction or in tandem according to at least one embodiment of the present disclosure. Specifically, FIG. 7A is a top view, and FIG. 7B is a longitudinal sectional view from the side after the two razor cartridge protective cases 10 of FIG. 7A have been cut in the C-C′ direction.

Referring to FIGS. 1, 2A, and 2B in conjunction with FIGS. 7A and 7B, any one of the first side wall 160 and the second side wall 180 may include one or more third coupling portions 165, and the other one of the first side wall 160 and the second side wall 180 may include one or more fourth coupling portions 185. For example, if the third coupling portion 165 is included in the first side wall 160, the fourth coupling portion 185 may be included in the second side wall 180, and conversely, if the third coupling portion 165 is included in the second side wall 180, the fourth coupling portion 185 may be included in the first side wall 160.

The following drawings and description of the disclosure illustrate that the first side wall 160 includes the third coupling portion 165 and the second side wall 180 includes the fourth coupling portion 185, but the present disclosure is not necessarily limited to this configuration. Accordingly, the description below may be equally applicable to embodiments in which the first side wall 160 includes the fourth coupling portion 185 and the second side wall 180 includes the third coupling portion 165.

Referring to FIGS. 1, 7A, and 7B, the third coupling portion 165 and the fourth coupling portion 185 may be configured to be detachably coupled to each other. The third coupling portion 165 and the fourth coupling portion 185 may be configured to be slidably coupled along the height direction, but the direction and manner of coupling are not necessarily limited thereto.

For example, as long as the razor cartridge protective cases 10 can be coupled to be elongated in the longitudinal direction, the third coupling portion 165 and the fourth coupling portion 185 may be elastically coupled to each other or may be slidingly coupled along the longitudinal direction or the lateral direction.

As such, the razor cartridge protective cases 10 according to at least one embodiment of the present disclosure may be configured to allow for longitudinal coupling as well as lateral coupling therebetween.

As shown in FIG. 1, any one of the first side wall 160 and the second side wall 180 may include a pair of third coupling portions 165 spaced apart from each other in the lateral direction, and the other one of the first side wall 160 and the second side wall 180 may include a pair of fourth coupling portions 185 spaced apart from each other in the lateral direction. However, each of the third coupling portion 165 and the fourth coupling portion 185 does not need to be a pair, and may be one, three, or more.

The pair of third coupling portions 165 may protrude in a direction away from the receiving space 100, and each third coupling portion 165 may be configured to extend laterally outwardly to form a second sliding space 170. In this case, between razor cartridge protective cases 10, the pair of fourth coupling portions 185 may be configured to be slidable within the second sliding spaces 170 along the height direction.

Referring to FIGS. 7A and 7B, when the pair of first side walls 160 and the pair of second side walls 180 are slidingly coupled along the height direction, the razor cartridge protective cases 10 may be prevented from being detached from each other in the lateral direction and the longitudinal direction.

However, the protruding direction of the pair of third coupling portions 165 is not necessarily limited to that in FIG. 1, and the pair of third coupling portions 165 may have portions that extend in a direction away from each other. For example, the pair of third coupling portions 165 may be shaped to have portions that protrude in a direction parallel to each other with the remaining portion extending in a direction away from each other.

Referring to FIGS. 7A and 7B, when the pair of third coupling portions 165 and the pair of fourth coupling portions 185 are slidably intercoupled, at least some of the pair of third coupling portions 165 may be configured to be located within the receiving space 100.

Thereby, two razor cartridge protective cases 10 that are coupled in the longitudinal direction or in tandem can be brought closer together, which establishes a more solid coupling between the razor cartridge protective cases 10.

Referring to FIGS. 1, 2A, and 2B, either of the first side wall 160 and the second side wall 180 may include a second fixing portion 260 configured to elastically couple with the other of the first side wall 160 and the second side wall 180. The elastic coupling may include, but is not necessarily limited to, at least one of a hook coupling, a latch coupling, and a snap-fit coupling. Thus, the elastic coupling may include all coupling methods utilizing elastic forces in addition to those coupling methods described above. The sliding coupling between the third coupling portion 165 and the fourth coupling portion 185 can be further strengthened by the second fixing portion 260.

The second fixing portion 260 is preferably included in a wall on which the third coupling portion 165 is formed, in which case the second fixing portion 260 may be configured to elastically couple with a wall in which the fourth coupling portion 185 is formed when the third coupling portion 165 and the fourth coupling portion 185 are slidingly coupled.

Referring to FIGS. 1, 2A, and 2B, the other of the first side wall 160 and the second side wall 180 may include a second fixing step 280 that limits movement of the second fixing portion 260 in the height direction when the second fixing portion 260 is elastically coupled. The second fixing step 280 may be included in the wall on which the fourth coupling portion 185 is formed. In this case, the second fixing step 280 may be configured to limit the upward movement of the second fixing portion 260 included in the wall formed with the third coupling portion 165, when the third coupling portion 165 and the fourth coupling portion 185 are slidingly coupled. However, the present disclosure is not necessarily limited to this configuration, and depending on the location of the second fixing portion 260 and the second fixing step 280 or how they are elastically coupled, the second fixing step 280 may limit downward movement of the second fixing portion 260, or may limit both upward and downward movement thereof.

FIGS. 1, 2A, and 2B illustrate that the protrusion direction of the second fixing step 280 in a direction away from the receiving space 100, but the second fixing step 280 is not necessarily limited to this protrusion direction as long as it is configured to limit the movement of the second fixing portion 260 in the height direction. For example, the second fixing step 280 may protrude toward the receiving space 100 or may have a recessed shape.

The other of the first side wall 160 and the second side wall 180 may include a third stop surface 275 configured to limit downward movement in the height direction of the third coupling portion 165. In this case, the second fixing step 280 may include a fourth stop surface 285 configured to limit upward movement in the height direction of the second fixing portion 260.

With the third coupling portion 165 and the fourth coupling portion 185 slidingly coupled, the third stop surface 275 may engage a lower portion of the third coupling portion 165, and the fourth stop surface 285 may engage an upper portion of the second fixing portion 260. Thereby, the third stop surface 275 and the fourth stop surface 285 may limit the height-direction movement of the third coupling portion 165 and the second fixing portion 260, respectively, thereby enabling a more solid sliding coupling of the third coupling portion 165 and the fourth coupling portion 185.

Referring back to FIGS. 2A and 2B, the first side wall 160 may include a pair of lateral first side walls 162 spaced apart from each other in the lateral direction and at least one central first side wall 164 disposed between the pair of lateral first side walls 162. Thus, hollow spaces may be formed between the at least one central first side wall 164 and the pair of lateral first side walls 162, which can reduce the amount of plastic utilized.

The second side wall 180 may include a pair of lateral second side walls 182 spaced apart from each other in the lateral direction and at least one central second side wall 184 disposed between the pair of lateral second side walls 182. Thus, hollow spaces may be formed between the at least one central second side wall 184 and the pair of lateral second side walls 182, which can reduce the amount of plastic utilized.

The pair of lateral first side walls 162 is preferably formed to positionally correspond to the pair of lateral second side walls 182 with respect to the longitudinal direction, and this is also true between the at least one central first side wall 164 and the at least one central second side wall 184.

Any one of the pair of lateral first side walls 162 and the pair of lateral second side walls 182 may include the third coupling portions 165, and the other one of the pair of lateral first side walls 162 and the pair of lateral second side walls 182 may include the fourth coupling portions 185.

Any one of the at least one central first side wall 164 and the at least one central second side wall 184 may include the second fixing portion 260, and the other one of the at least one central first side wall 164 and the at least one central second side wall 184 may include the second fixing step 280.

The pair of third coupling portions 165 may be symmetrical in the lateral direction relative to the point where the second fixing portion 260 is formed, and the pair of fourth coupling portions 185 may be symmetrical in the lateral direction relative to the point where the second fixing step 280 is formed. This allows implementation of the razor cartridge protective case 10 having the pair of third coupling portions 165 and the pair of fourth coupling portions 185 that can be reliably coupled while minimizing the amount of plastic material used.

Referring to FIG. 2B, the pair of fourth coupling portions 185 may be formed with a third inclined guide surface 270 that is inclined with respect to the height direction. For example, the third inclined guide surface 270 may be formed to be inclined toward the lateral direction with respect to the height direction.

When the third coupling portion 165 and the fourth coupling portion 185 are slidingly coupled between the razor cartridge protective cases 10, the third inclined guide surface 270 may be configured to guide the coupling direction of the third coupling portion 165. For example, when the third coupling portion 165 initiates a sliding engagement in the height direction at the top of the fourth coupling portion 185, the third inclined guide surface 270 can facilitate alignment of the third coupling portion 165 with the fourth coupling portion 185.

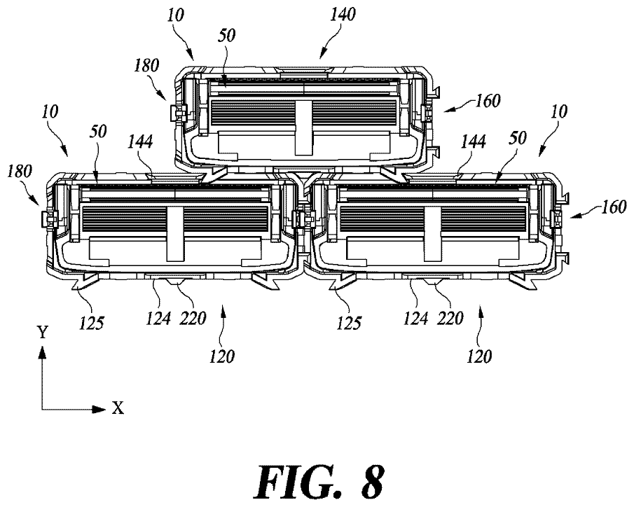

FIG. 8 is a diagram illustrating three razor cartridge protective cases 10 coupled in the longitudinal direction and the lateral direction, according to at least one embodiment of the present disclosure.

Referring to FIG. 8, after coupling two razor cartridge protective cases 10 in the longitudinal direction or in tandem, one can further couple one razor cartridge protective case 10 in the central region in the lateral direction.

The first fixing portion 220 of the razor cartridge protective case 10 coupled in the lateral direction may be located between the two razor cartridge protective cases 10 coupled in the longitudinal direction and may be sandwiched by press fitting or slidingly coupled between the two cases.

The pair of first coupling portions 125 of the razor cartridge protective case 10 to be coupled in the lateral direction may be detachably coupled to at least one central rear wall 144 or at least one central front wall 124 of the two razor cartridge protective cases 10 that are coupled in the longitudinal direction. To this end, the central rear wall 144 or the central front wall 124 may have a structure engageable with the first coupling portions 125. For example, if the first coupling portion 125 has a diagonally protruding shape, the central rear wall 144 or the central front wall 124 may have a correspondingly inclined surface. The coupling method in this regard may be the same as the coupling method of the two razor cartridge protective case 10 in the longitudinal direction and/or lateral direction described above.

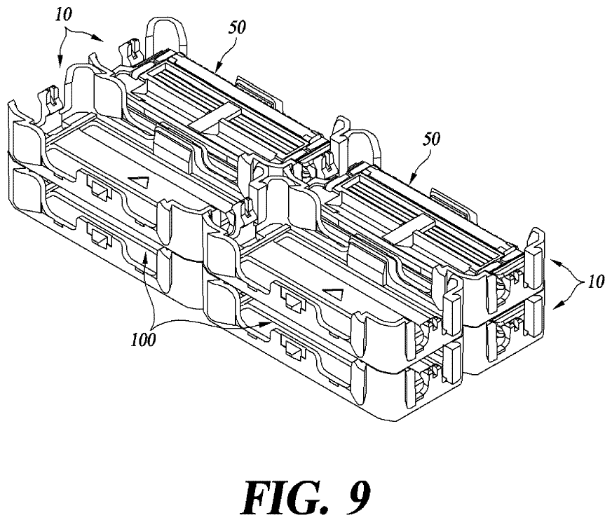

FIG. 9 is a diagram illustrating eight razor cartridge protective cases 10 coupled in the lateral direction, the longitudinal direction, and the height direction, according to at least one embodiment of the present disclosure.

Referring to FIG. 9, multiples of the razor cartridge protective case 10 according to at least one embodiment of the present disclosure may be coupled as needed in front-to-back, up-and-down, and side-to-side configurations. Thus, the amount of plastic material required to accommodate a plurality of razor cartridges 50 can be minimized by the razor cartridge protective cases 10 as compared to a single dispenser configuration.

Depending on the number of razor cartridges 50 required, the user may conveniently adjust the overall size and number of razor cartridge protective cases 10. This has the effect of reducing the overall manufacturing cost by providing the razor cartridge protective case 10 with the double duty as both a protective case and a dispenser, minimizing the amount of plastic material used to otherwise produce the protective case, dispenser, and the like.

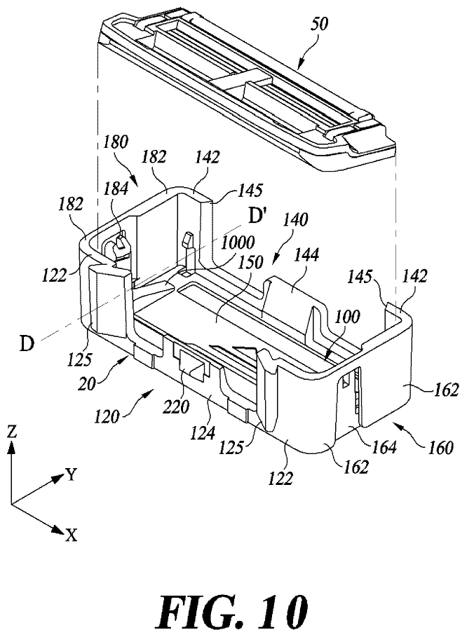

FIG. 10 is an exploded view of a razor cartridge protective case 20 according to another embodiment of the present disclosure.

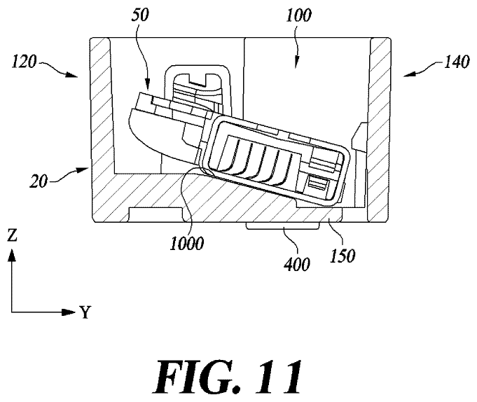

FIG. 11 is a sectional view from the side of the razor cartridge protective case 20 of FIG. 10 with the razor cartridge 50 seated and cut in the direction D-D′.

Except as specifically described below, the description of the razor cartridge protective case 10 according to at least one embodiment of the present disclosure is equally applicable to the razor cartridge protective case 20 according to another embodiment of the present disclosure.

Referring to FIGS. 10 and 11, the razor cartridge protective case 20 according to another embodiment is configured to receive the razor cartridge 50 in the receiving space 100 at an inclined angle. This is to facilitate engagement between the razor cartridge 50 and a separate razor handle (not shown) while the razor cartridge 50 is received in the razor cartridge protective case 20.

To receive the razor cartridge 50 inclined into the receiving space 100, at least one inclined surface 1000 may be formed on the base 150. At least one or more inclined surfaces 1000 may be configured to be at least partially inclined with respect to the lateral direction, such as a direction parallel to the Y-axis, to receive the razor cartridge 50 inclined into the receiving space 100. The inclined surfaces 1000 may be formed on the longitudinally opposite sides of the base 150, respectively. However, unlimited to this configuration, the inclined surface 1000 may be formed in a longitudinally central region of the base 150.

To facilitate engagement between the razor cartridge 50 and the separate razor handle, the razor cartridge 50 may be received in the receiving space 100 such that it forms an angle of, but is not limited to, approximately 15° with respect to the lateral direction.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. At least one razor cartridge protective case each comprising a receiving space configured to receive at least a portion of a razor cartridge extending in a longitudinal direction, the at least one razor cartridge protective case each comprising:
a front wall disposed at a front of the receiving space; and
a rear wall disposed at a rear of the receiving space and opposing the front wall in a lateral direction perpendicular to the longitudinal direction,
wherein one of the front wall or the rear wall comprises one or more first coupling portions,
wherein the other one of the front wall or the rear wall comprises one or more second coupling portions, and
wherein the first coupling portion is detachably coupled to the second coupling portion of an another razor cartridge protective case along a height direction perpendicular to the longitudinal direction and the lateral direction.

2. The at least one razor cartridge protective case of claim 1, wherein one of the front wall or the rear wall comprises a pair of first coupling portions spaced apart from each other in the longitudinal direction,
wherein the other one of the front wall or the rear wall comprises a pair of second coupling portions spaced apart from each other in the longitudinal direction,
wherein the pair of first coupling portions protrude in a direction away from the receiving space to form a sliding space, and
wherein the pair of second coupling portions are slidable within the sliding space of the another razor cartridge protective case in the height direction.

3. The at least one razor cartridge protective case of claim 2, wherein, while the pair of first coupling portions are slidingly coupled to the pair of second coupling portions of the another razor cartridge protective case, at least a portion of the pair of the first coupling portions is located within the receiving space of the another razor cartridge protective case.

4. The at least one razor cartridge protective case of claim 2, wherein at least some of the pair of first coupling portions protrude in a direction away from each other.

5. The at least one razor cartridge protective case of claim 2, wherein each of the pair of second coupling portions comprises:
a first inclined guide surface formed on the second coupling portion to be inclined with respect to the height direction,
wherein the first inclined guide surface is configured to guide a coupling direction of the first coupling portion in response to the first coupling portion being slidingly coupled to the second coupling portion of the another razor cartridge protective case.

6. The at least one razor cartridge protective case of claim 1, wherein one of the front wall or the rear wall further comprises:
a first fixing portion elastically coupled to a corresponding one of the front wall and the rear wall of the another razor cartridge protective case.

7. The at least one razor cartridge protective case of claim 6, wherein the other one of the front wall or the rear wall comprises:
a first fixing step that limits a movement of the first fixing portion in the height direction om response to the first fixing portion being elastically coupled.

8. The at least one razor cartridge protective case of claim 7, wherein the other one of the front wall or the rear wall comprises a first stop surface configured to limit downward movement in the height direction of the first fixing portion, and
wherein the first fixing step comprises a second stop surface configured to limit the movement of the first fixing portion in the height direction and in an upward direction.

9. The at least one razor cartridge protective case of claim 1, further comprising:
a first side wall and a second side wall disposed on longitudinal sides of the receiving space between the front wall and the rear wall,
wherein one of the front side wall or the second side wall comprises a third coupling portion,
wherein the other one of the first side wall or the second side wall comprises a fourth coupling portion, and
wherein the third coupling portion is detachably coupled to the fourth coupling portion of an another razor cartridge protective case.

10. The at least one razor cartridge protective case of claim 1, wherein at least one of the front wall or the rear wall comprises:
a second inclined guide surface formed on at least one of the front wall or the rear wall to be inclined with respect to the height direction,
wherein the second inclined guide surface is configured to guide the razor cartridge when the razor cartridge is received in the receiving space.

11. The at least one razor cartridge protective case of claim 1, wherein the front wall comprises a pair of longitudinal front walls spaced apart from each other in the longitudinal direction and at least one center front wall disposed between the pair of longitudinal front walls, and
wherein the rear wall comprises a pair of longitudinal rear walls spaced apart from each other in the longitudinal direction and at least one central rear wall disposed between the pair of longitudinal rear walls.

12. The at least one razor cartridge protective case of claim 11, wherein one of the pair of longitudinal front walls or the pair of longitudinal rear walls comprise the first coupling portion, and
wherein the other one of the pair of longitudinal front walls or the pair of longitudinal rear walls comprise the second coupling portion.

13. The at least one razor cartridge protective case of claim 1, further comprising:
a base disposed at a lower portion of the receiving space and comprising a base upper surface adjacent to the receiving space and a base lower surface opposite the base upper surface, and
wherein the base lower surface comprises an upper and lower coupling portion coupled to at least one of the front wall, the rear wall, the first side wall, and the second side wall of an another razor cartridge protective case at one end extending along the height direction.

14. The at least one razor cartridge protective case of claim 13, wherein the base comprises:
at least one opening corresponding to at least one of a guard and a cap of the razor cartridge.

15. The at least one razor cartridge protective case of claim 1, further comprising:
a base disposed at a lower portion of the receiving space and comprising at least one inclined surface configured to be inclined with respect to the lateral direction.

16. At least one razor cartridge protective case each comprising a receiving space configured to receive at least a portion of a razor cartridge extending in a longitudinal direction, the at least one razor cartridge protective case each further comprising:
a first side wall disposed on one side of the receiving space; and
a second side wall disposed on the other side of the receiving space and configured to be opposed to the first side wall in the longitudinal direction,
wherein one of the front side wall or the second side wall comprises one or more third coupling portions,
wherein the other one of the first side wall or the second side wall comprises one or more fourth coupling portions, and
wherein the third coupling portion is detachably coupled to the fourth coupling portion of an another razor cartridge protective case.

17. The at least one razor cartridge protective case of claim 16, wherein the third coupling portion is configured to be slidably coupled to the fourth coupling portion of the another razor cartridge protective case along a direction parallel to a height direction perpendicular to the longitudinal direction.

18. The at least one razor cartridge protective case of claim 16, wherein one of the front side wall or the second side wall comprises a pair of third coupling portions spaced apart from each other in a lateral direction,
wherein the other one of the first side wall or the second side wall comprises a pair of fourth coupling portions spaced apart from each other in the lateral direction,
wherein the pair of third coupling portions are configured to protrude in a direction away from the receiving space to form a sliding space, and
wherein the pair of fourth coupling portions are slidable within the sliding space of the another razor cartridge protective case in a direction parallel to a height direction perpendicular to the longitudinal direction.

19. The at least one razor cartridge protective case of claim 16, wherein one of the front side wall or the second side wall further comprises:
a second fixing portion configured to be elastically coupled to a corresponding one of the first side wall and the second side wall of the another razor cartridge protective case.

20. The at least one razor cartridge protective case of claim 19, wherein the other one of the first side wall or the second side wall comprises:
a second fixing step that, in response to the second fixing portion being elastically coupled, limits a movement of the second fixing portion in a height direction perpendicular to the longitudinal direction.
